(19) United States
(12) Patent Application Publication
(10) Pub. No.: US 2026/0128183 A1
(43) Pub. Date: May 7, 2026

(54) System and Method for Energy Recovery in a Beam Collider

(71) Applicant: Evgueni Tsiper, Eagan, MN (US)

(72) Inventor: Evgueni Tsiper, Eagan, MN (US)

(21) Appl. No.: 19/437,291

(22) Filed: Dec. 30, 2025

Related U.S. Application Data
(62) Division of application No. 17/239,435, filed on Apr. 23, 2021, now abandoned.
(60) Provisional application No. 63/014,405, filed on Apr. 23, 2020.
(60) Provisional application No. 63/085,157, filed on Sep. 30, 2020.

(51) Int. Cl. G21B 3/00

(52) U.S. Cl. CPC G21B 3/006

(57) ABSTRACT

Energy-recovery system and method for a beam collider. A first ion beam and a second ion beam are directed within an active space along a first path and a second path, respectively. Each ion beam has essentially uniform energies of ions within each ion beam, and essentially uniform velocity vectors of ions within each beam at points within each path of each respective ion beam. The first and the second ion beams are caused to collide substantially head-on with each other within a collision zone in the active space, where the ratio of the energy of the ions of the first beam to the energy of the ions of the second beam equals the inverse ratio of the respective ion masses. Energy of the scattered ions of the first ion beam and the second ion beam is recovered, and cold ions are evacuated from the active space.

### PRIOR APPLICATIONS

This application is a Divisional Application of U.S. application Ser. No. 17/239,435 filed Apr. 23, 2021 which claims the benefit of U.S. Provisional Application No. 63/014,405 filed Apr. 23, 2020, and U.S. Provisional Application No. 63/085,157 filed Sep. 30, 2020, the disclosures of each of which are incorporated by reference herein.

### TECHNICAL FIELD

Embodiments described herein relate generally to nuclear fusion and, more particularly, to apparatus and associated methodology that facilitates the recovery of energy which would otherwise be lost due to elastic scattering of ions.

### BACKGROUND

A nuclear fusion reaction occurs when two ions of a certain kind hit each other at energies large enough for them to overcome Coulomb repulsion and approach each other at distances of the order of 10-14 m, about 10,000 times smaller than the size of an atom. Consequently, the kinetic energy required is about 10,000 times larger than typical chemical energies. The energy required is tens or hundreds keV (kilo-electron-volts), or, equivalently, hundreds or millions Kelvins on the temperature scale.

The majority of fusion experiments attempt to heat plasma to the required temperatures so as to allow random ion collisions to cause fusion reactions. The high temperatures involved require confinement of the plasma, either magnetic, inertial, electrostatic, or a combination thereof, in order to protect the apparatus from the hot plasma inside. Confining and maintaining hot plasma is a formidable task that has yet to result in a controlled sustainable fusion reaction. An alternative approach is to accelerate the ions by means of electric potential, which only requires modest voltages of tens or hundreds kV. However, certain fundamental obstacles reviewed below are believed to preclude net energy gain in such a “kinematic” arrangement. The term “kinematic” in the present context refers to systems that are not in thermal equilibrium (i.e. “nonthermal”) and involve particles with energies greater than ambient temperatures.

One example of why kinematic approaches do not work is usually to consider an energetic ion beam hitting a solid target. Since the fusion cross-section is so small (about 10,000² times smaller) compared to the squared distances between the atoms in the target, an average ion will have to traverse a great many atomic layers until it has a chance of hitting a nucleus. Such an ion will be stopped at a much shorter distance by the electrons in the target.

Even in configurations with no electrons present, a fast ion has a much greater chance of hitting another ion closely enough to scatter elastically but not dead-on to cause fusion. The ions that scatter elastically redistribute their kinetic energies between them, causing a cascading process that quickly leads to thermalization, i.e., the loss of the initial energy to heat. There are only two possible outcomes of thermalization: either the heat leads to the overall temperature sufficient for sustaining fusion, bringing the device to the class of plasma confining devices (not discussed here), or (ii) the temperatures are lower than fusion temperatures, in which case the energy lost to heat is unrecoverable fully due to the laws of thermodynamics, thereby precluding net energy gain. In other words, unless a very hot plasma is formed, much more energy has to be spent on accelerating the ions that are unsuccessful at fusion than any gain produced by the very few that are successful.

A further example is a fusor device—the simplest device that achieves fusion reaction by means of electrostatic potentials, albeit no net positive gain has been demonstrated so far.

Notably, the task of achieving fusion is not difficult; a fusor is a simple device that may be built at home or in a garage setting. Fusors are used commercially as neutron sources. The difficult, and still unsolved, task is to make a sustainable fusion reaction that can feed itself through net energy gain. Energy losses in a typical fusor device are five orders of magnitude larger than the fusion power produced.

A typical fusor device does not fall into the class of kinematic fusion approaches. Rather, a fusor device is more correctly classified as an Inertial Electrostatic Confinement (IEC) device-one that still employs hot plasma, shielded from the outside apparatus by electrostatic, rather than magnetic, fields. The reason for fusors being IECs is that they share the same fundamental channel for energy thermalization. The ions in the fusor device are accelerated by electrostatic bias when they fly from the outer wall towards the center. In the center, the average kinetic energy of the ions is large enough to undergo fusion. Two cold ions accelerated towards the center from the outer wall have the same energy when they reach the center. They have a chance to hit each other and cause fusion, but they also have a much greater chance to scatter elastically and re-distribute their energy between themselves.

When two particles scatter elastically, they generally re-distribute their energies. This is true even for identical particles with the same initial energies, which can be visualized on a billiard table: it is possible, for instance, for two identical billiard balls with the same speed to collide in such a manner that one of them stops and the other flies away with twice the energy. The process is the exact reverse of a billiard ball hitting a stationary billiard ball. Energy re-distribution due to elastic scattering leads to thermalization.

The same fundamental obstacle applies to other configurations that attempt to achieve sustainable fusion via accelerated ion beams. In addition to the usually-quoted problem of beam de-focusing due to internal electrostatic pressure, the same process causes many more ions to be elastically scattered away, carrying their energy away with them, than the few that cause fusion, precluding net energy gain.

### SUMMARY OF THE DISCLOSURE

In one inventive aspect, a fusion reactor has a vacuum chamber maintaining a deep vacuum. A first ion beam and a second ion beam are directed within an active space along a first path and a second path, respectively. Each ion beam has essentially uniform energies of ions within each ion beam, and essentially uniform velocity vectors of ions within each beam at points within each path of each respective ion beam. The first and the second ion beams are caused to collide substantially head-on with each other within a reaction zone in the active space, where the ratio of the energy of the ions of the first beam to the energy of the ions of the second beam equals the inverse ratio of the respective ion masses. Energy of the scattered ions of the first ion beam and the second ion beam is recovered, and cold ions are evacuated from the active space.

Another inventive aspect is directed to a nuclear fusion reactor that includes a vacuum chamber defining an interior and operative to maintain a deep vacuum in the interior. The reactor further includes at least one ion injection port, an ion energization circuit, and an active space within the interior. The active space comprises an ion beam focusing arrangement that includes a plurality of electrodes arranged to direct a first ion beam and a second ion beam to have essentially uniform energies of ions within each beam, and essentially uniform velocity vectors at points within each path of each respective ion beam, and to collide substantially head-on with each other within a reaction zone in the active space. Each ion beam is sourced via the at least one ion injection port, and the ratio of the energy of the ions of the first beam to the energy of the ions of the second beam equals the inverse ratio of the respective ion masses.

A first energy recovery electrode is coupled with the ion energization circuit, and is positively biased according to charge and energy of the first ion beam. It is operative to transfer kinetic energy of scattered ions of the first ion beam to the ion energization circuit, thereby producing cold ions to be evacuated from the active space.

### BRIEF DESCRIPTION OF THE DRAWINGS

The invention may be more completely understood in consideration of the following detailed description of various embodiments of the invention in connection with the accompanying drawings.

FIG. 1 is a simplified schematic diagram illustrating a portion of an exemplary nuclear fusion device in accordance with some embodiments, further details of which are illustrated in greater detail in the following drawings.

FIG. 2 is a simplified schematic diagram illustrating some exemplary aspects of a nuclear fusion device in accordance with a first type of embodiment in which ion beams are directed along a main axis towards the reaction zone.

FIG. 3 is a simplified schematic diagram illustrating a nuclear fusion device according to some embodiments in which an ion storage ring is arranged to cross itself at 180° in the reaction zone.

FIG. 4 is a simplified schematic diagram illustrating a portion of a nuclear fusion device according to some embodiments in which the ion beams are directed along a leaf-shaped path, such that the forward and backward directions of the ions are spatially separated.

FIG. 5 is a simplified schematic diagram illustrating a dual-species nuclear fusion device according to some embodiments that utilizes two leaf-shaped loops similar to the leaf-shaped loop depicted in FIG. 4.

FIG. 6 is a simplified schematic diagram illustrating a dual-species nuclear fusion device according to some embodiments that utilizes two ion storage rings.

FIG. 7 is a simplified schematic diagram illustrating a dual-species nuclear fusion device according to some embodiments that has storage rings contained entirely inside the active space of the device.

FIG. 8 is a simplified schematic diagram illustrating an exemplary electrical circuit that may be adapted for use with various embodiments, which includes electrodes and their connections to the ion energizing portion according to some embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION

One aspect of the embodiments is directed to providing an arrangement for efficient recovery of the bulk of the energy carried away by the elastically scattered ions in a kinematic fusion reactor.

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

In addition, the accompanying drawings, which are included to provide a further understanding of aspects of the inventive subject matter are incorporated in and constitute a part of this specification, illustrate an embodiment of the invention and together with the description serve to explain the principles of the subject matter. They are meant to be exemplary illustrations provided to enable persons skilled in the art to practice the disclosure and are not intended to limit the scope of any potential claims, unless such limitation is expressly set forth in a respective claim.

### Certain Terms Used Throughout the Description

Vacuum chamber is the vessel where a deep vacuum is maintained. In this context, a deep vacuum is one where the mean-free path of any residual particle is larger than the dimensions of the vacuum chamber. The fusion reaction is contained only in a small reaction zone near the center of the vacuum chamber.

Reaction zone is a region at or near the center of the accelerating electrode where the colliding beams overlap to allow head-on collisions and where the fusion reaction takes place. The reaction zone is defined by the beam overlap area where the kinetic energy of the beams is sufficient for the reaction to occur.

Active space is a 3D (three-dimensional) area within the vacuum chamber that includes the reaction zone, as well as a greater area generally surrounding at least portions of the reaction zone, and including the area(s) where the energetic (non-cold) directed ion beams and scattered ions are present during operation of the fusion reactor. The active space does not necessarily have a strictly-defined boundary. In some embodiments, the extent of the active space may generally correspond with the location of the energy recovery electrode(s), whereas in other embodiments, the extent of the active space may be interior, or exterior, with respect to the energy recovery electrode(s).

Main axis is the axis along which the colliding beams in the reaction zone are aligned.

Ion injection port is an aperture or other structure that permits an ion beam to enter the active space from an ion source.

Ion collection port is an aperture or other structure that permits an ion beam of non-reacted and un-scattered ions, having passed through the reaction zone, to exit the active space. The ion beam exiting the active space may be directed to reenter the active space, or the beam may have its energy recovered, according to various embodiments.

Design deviation angle is an offset angle which can be zero or have a small value to separate the ion injector and collector ports in some Basic Designs, as defined below. Accelerating electrode is an electrode that may be shaped essentially as a cylinder or ring and oriented essentially co-axially with the Main Axis.

Energy recovery electrode is an electrode which is positively biased at approximately the energy of the ions at the Reaction zone times their electric charge, and situated in the path of the scattered ions, surrounding the reaction zone at an essentially complete solid angle (in one type of embodiment) or covering an essential part of the solid angle where the majority of the ions are scattered. The energy recovery electrode may be porous enough to allow cold ion evacuation. The evacuation efficiency is preferably sufficient to prevent a significant number of post-scattered ions from accelerating again towards the reaction zone. In some embodiments, the electrode may have a number of segments biased with respect to each other for improved energy recovery efficiency.

Cold, or slow, ions are ions that have kinetic energies less than 0.1% of the kinetic energy of the “fast” or “accelerated” ions in the reaction zone. The accelerated ions have energies in the range of tens or thousands of electron-Volts. The specific value (E₁, E₂ in Eq. 1b) is chosen to optimize the device performance, and is typically close to the value that maximizes the nuclear reaction cross-section. For instance, in the case of D-T reaction these energies are E_{D}=37.5 keV and E_{T}=25 keV for the deuterium and tritium ions, respectively. As will be described below, fusion reactors in accordance with some embodiments are operative to decelerate such hot ions if and when they undergo an elastic scattering event and to evacuate the resulting cold ions from the active space.

### Preventing Energy Redistribution of Colliding Ions

The approach central to the present disclosure, according to some embodiments is based on the realization that energy re-distribution is absent in the center-of-mass (CM) frame for a particular collision event. An elastic scattering event in the CM frame results in both particles changing the direction of their flight, but not their energies. Scattered ions fly away in opposite directions that can be at any angle χ to their initial paths, but their energies remain equal to their initial energies. This property is used in various embodiments to help recover the energy of the scattered ions before their energy is lost to heat.

According to some embodiments, as described in detail below, the laboratory (device) frame essentially coincides with the CM frame for the vast majority of the ion collisions. Utilizing this principle, the kinetic energy of the “wasted” scattered ions maintains a well-defined value and can therefore be recovered by slowing them down with electrostatic potentials, so that the energy is returned back to the electric circuit from which it was originally drawn to accelerate those ions. Notably, a fundamental obstacle which these embodiments address is not the waste of the scattered ions themselves, but the waste of energy carried by them.

Having the CM frame coincide with the laboratory frame for the majority of the ion collisions helps to effect the energy recovery, because otherwise the scattered ions will have a broad spectrum of different energies, preventing their deceleration with a finite number of electrodes.

In order for the device frame to serve as the CM frame the collisions have to be essentially head-on, and the colliding ion energies Eᵢ have to be carefully tuned to be inversely proportional to the ion masses mi:

$$Collision angle = {180}^{∘} , \qquad ( Eq . 1 a )$$

$${E}_{1} : {E}_{2} = {m}_{2} : {m}_{1} . \qquad ( Eq . 1 b )$$

These conditions can be achieved according to some embodiments by preparing two ion beams (which can take the form of storage rings similar to the ones described in U.S. Pat. No. 5,152,955 to Russell, or Alessandro Ruggiero, Proton-Boron Colliding Beams for Nuclear Fusion, Proceedings of the 8th International Conference on Nuclear Engineering (2000), the disclosures of which are incorporated by reference herein, except that the two ion beams have well-calibrated energies, conforming to Eq. (1b), and collide preferably head-on at the center of the reaction chamber.

In this context, well-calibrated energies of an ion beam means that all ions within that beam have essentially (i.e., to the extent practicable) uniform energy and essentially uniform velocity vectors along the path of the ion beam. For example, the well-calibrated energies in one such embodiment may have an energy distribution and distribution of velocity vectors on the order of 1 ppm.

Ion energy can be controlled by applying appropriate accelerating voltages along the beam paths. Ion focusing can be controlled by arranging suitable configuration of focusing electrodes or magnets along the beam paths. The spatial dimensions of the collision (“Reaction”) area can be defined by deflecting and bending the beam tracks with low or moderate-strength magnetic fields, using suitable techniques which are known, or other suitable techniques which may arise in the future. In this context, low or moderate-strength magnetic fields are magnetic fields of a strength that may be produced using permanent magnets (regardless of how the fields are actually produced). For instance, fields on the order of 0.1T-0.3T may be employed.

Any deviation of the collision angle from 180° quickly breaks down the unique property of the CM frame, allowing for energy redistribution, thereby making the task of recovering the energy of the scattered particles much harder, if not impossible. Accordingly, in these embodiments, the collision angle is maintained as closely as practicable to 180° for a head-on collision. For instance, each beam may be adjusted to be within 0.1° of its nominal beam direction. In other examples, the beam direction is dynamically adjustable, e.g., using electric fields, using microactuators, or a combination of techniques such as these, to aim the beam emitters. A control system may be employed to dynamically adjust the beam directions so as to maximize the power output of the reactor.

### Additional Energy Recovery Features

Equations 1a and 1b above provide conditions for the post-scattered ions to have energies essentially identical to their initial energies, thereby setting the stage for the recovery of their energies. The actual energy recovery can be implemented by placing an electrode in the path of these ions, biased with a positive electric potential equal to their energy times their electric charge. Such an energy recovery arrangement may be further improved by having the ions approach the energy recovery electrode at a normal (or close-to-normal) angle:

$$Energy Recovery Incidence angle = 9 {0}^{∘} \qquad ( Eq . 2 )$$

In the absence of this arrangement, if an ion approaches the electrode at an angle other than normal it is reflected back, unless the electrode is sufficiently under-biased. If the electrode is under-biased, the ion is not reflected back, but some fraction of its energy associated with its tangential motion is not recovered. Equation (2) facilitates a straightforward energy recovery configuration, as described in greater detail below.

### Same-Species and Dual Species Reactions

In the case of the two ion species being the same, the design problem simplifies to maintaining head-on collisions of ions having the same exact energies. The cost of this simplification is a narrower scope of admissible nuclear reactions, such as D-D, T-T, or the aneuronic ³He-³He (where D represents deuterium, T represents tritium, and He represents Helium nuclei).

These reactions, specifically D-D, have significantly smaller fusion cross-sections OF as well as fusion yields Er, which leads to a constrained (but still favorable) energy balance, as calculated below. On the other hand, using the single-species reaction allows for consideration of simpler device designs.

The design principles described above may be achieved by a number of different device geometries. Various embodiments are described below, beginning with a single-species embodiment that adds improvements to a conventional fusor device geometry. In addition, different same-species reactor geometries, and dual-species reactor geometries are described in accordance with other embodiments.

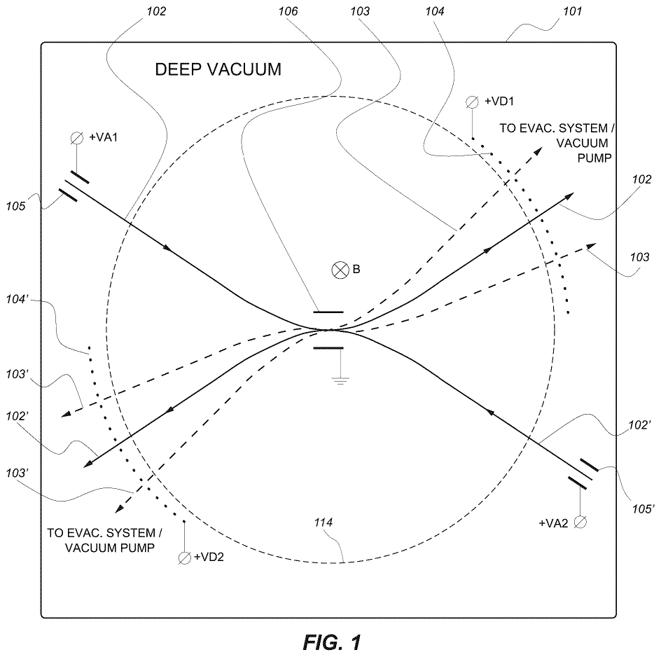

FIG. 1 is a simplified diagram illustrating certain basic aspects pertaining to various embodiments described in the following sections. As depicted, vacuum chamber 101 maintains a deep vacuum, which may be established and maintained using a suitable evacuation system (not shown), which may include a vacuum pump and suitable plumbing. Also contained within vacuum chamber 101 are active space 114, within which the reaction zone 106, ion sources 105 and 105′, and energy-recovery electrodes 104 and 104′ are located.

Ion sources 105, 105′ may be implemented using electrodes maintained at positive accelerating voltages+VA1 and +VA2 with respect to the reaction zone 106 in order to produce ion beams 102 and 102′, respectively, at beam energies specified by Eq. 1b.

Ions that undergo elastic scattering in reaction zone 106 follow scatter paths similar to 103 or 103′. Energy recovery electrodes 104 and 104′ are maintained at positive decelerating voltages+VD1 and +VD2 to recover the kinetic energy of the scattered ions along scatter paths 103 or 103′, which are thereafter removed from active space 114 by the evacuation system.

Notably, since the device, including energy recovery electrodes 104 and 104′ is a 3D structure, scattered ion paths 103 and 103′ may be outside of the plane of the diagram, meaning they can be at any angle in 3D space.

Ions that do not undergo elastic scattering continue on their respective paths 102 or 102′. In some embodiments these ions are also decelerated essentially completely, and in some other embodiments these un-scattered ions are circulated back into the active space 114. Furthermore, in the embodiments where the un-scattered ions are decelerated, the resulting cold ions are also removed from the active zone in some embodiments, or, in yet some other embodiments, are not removed, but are re-used by allowing them to be accelerated again towards the reaction zone. In any configuration, the energy loss associated with these un-scattered ions is minimized, whether the ions themselves are re-used or not, because the energy spent on their acceleration is either recovered or re-used. Magnetic field B, shown as being perpendicular to the plane of the diagram in this example, bends the paths of the ion beams in such a way as to promote head-on collisions (Eq. 1a) in reaction zone 106.

### Embodiments of Basic Design I

Basic Design I comprises an improved conventional fusor device, which, unlike the conventional fusor, is operated in a deep vacuum regime, and is equipped with certain design elements, as detailed below. Basic Design I is operative to concentrate the distribution of ions over the coordinate and velocity spaces in such a manner as to (i) substantially increase the probability of same-energy head-on collisions in the reaction zone, (ii) efficiently evacuate the ions scattered to angles inconsistent with the one-dimensional (1D) space distribution maintained, and (iii) efficiently collect the kinetic energy of such post-scattered ions and return it back to the electric circuit before thermalization occurs. This back energy transfer is made possible in the Basic Design I embodiment by restricting the majority of the collisions to be only head-on collisions of same-mass, same-energy ions, whereby the energies of the scattered particles are known precisely to within narrow tolerances.

Notably, conventional fusor designs lack such capability of retrieving the post-scattered ion energy substantially entirely and thus avoiding thermalization. Therefore, the operation of the device in accordance with Basic Design I differs significantly from that of the known fusor devices, with the latter having high-temperature plasma in the central area. By contrast, Basic Design I replaces such high-temperature plasma with a narrow, highly non-thermal energy and velocity distribution.

Additionally, known fusor devices suffer from energy losses due to the hot ions striking the accelerating electrode, whereas the Basic Design I practically eliminates this second critical energy loss channel, because the 1D path of the ions does not cross the axially-symmetric accelerating electrode.

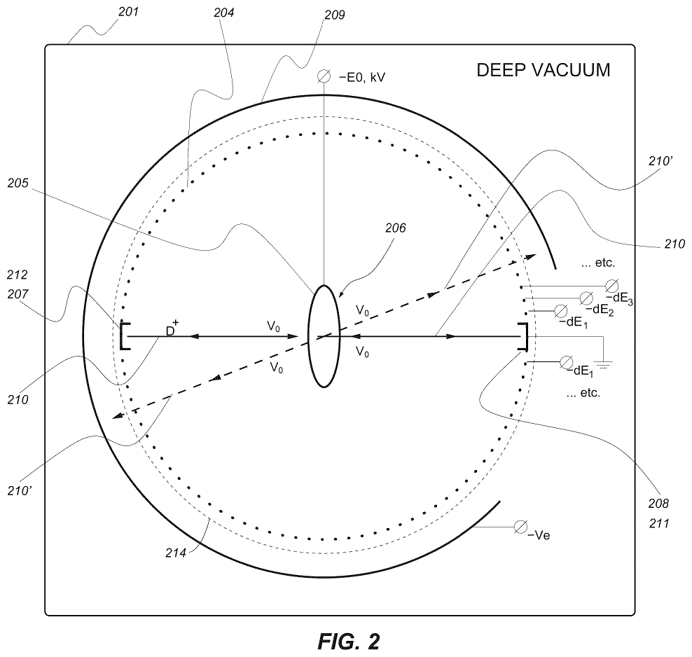

FIG. 2 is a simplified diagram illustrating an embodiment in accordance with Basic Design I. In this example, the preferred shape of the device is spherical about the reaction zone 206. Ion injection ports 207 and 208, at least one of which is associated with cold ion injector(s) (not shown), are situated at or near the poles of the device, essentially co-axial with main axis 210. The cold ion injectors supply initial ion density consistent with the 1D nature of the spatial and velocity distributions desired. The cold ions entering active space 214 from the two opposite poles accelerate along main axis 210 towards reaction zone 206 at the center by the electrostatic attraction force created by the negatively-biased accelerating electrode 205.

Upon head-on collision or a missed collision, the non-reacted and un-scattered ions (the majority thereof) leave reaction zone 206 along main axis 210, decelerate due to the electric field produced by the potential difference between energy recovery electrode 204 and accelerating electrode 205, and transfer energy back to the circuit as they reach the opposite side of energy recovery electrode 204.

The majority of the ions, un-scattered or scattered elastically to small enough angles, are collected by two ion collection ports 211 and 212. In the example depicted in FIG. 2, the ion collection ports 211 and 212 coincide with the opposite ion injection ports 207 and 208, thus allowing the collected ions to accelerate back towards reaction zone 206 again.

The ions that undergo an elastic scattering event leave reaction zone 206 along paths similar to 210′ and having initial velocities v₀ identical to that of the un-scattered ions. These ions approach the energy recovery electrode 204 at a normal incidence angle (as per Eq. 2), slow down under the positive potential bias of energy recovery electrode 204 and transfer nearly all of their kinetic energy back to the electric circuit, then pass beyond energy recovery electrode 204 and are collected and removed by cold ion evacuation system 209.

Energy recovery electrode 204, surrounding reaction zone 206, is positively biased with respect to accelerating electrode 205 in such a manner as to nearly, but not completely, reduce the energy of the ions that reach it, and to allow the cold ions to pass through it to be collected by cold ion evacuation system 209. In some embodiments, energy recovery electrode 204 has an ion-permeable construction (e.g., mesh or perforated) to permit the cold ions to be evacuated from active space 214 via cold ion evacuation system 209.

Cold ion evacuation system 209, a portion of which is shown schematically as an arc, may include a system maintaining the vacuum; it may contain one or more negatively-biased capture electrodes (not shown) to recombine the positive ions by supplying electrons and thereby converting the ions to neutral atoms (e.g. deuterium or helium-3) to be further removed by the vacuum system. It may further comprise electrodes made of palladium, properly biased to absorb deuterium or tritium, so as to prevent the emission of the cold ions back into active space 214. Cold ion evacuation system 209 may utilize any suitable construction or technology, such as turbo-molecular, diffusion, or cryogenic.

In one embodiment, vacuum chamber 201 may contain elements designed to attract and absorb any ions that pass though energy recovery electrode 204 and disallow their secondary emission towards the center of active space 214. Such elements may comprise palladium or other absorbing materials; or they may comprise an electrode (such as the arc of cold ion evacuation system 209), slightly negatively biased with respect to energy recovery electrode 204 so as to attract and absorb any ions that pass though energy recovery electrode 204. Such an electrode may be made of or contain palladium or other absorbing material for a combined benefit.

Accordingly, the described geometry of this embodiment satisfies both Equations 1a and 1b, as well as Equation 2 for the ions scattered elastically at any angle.

In some other embodiments energy recovery electrode 204 may perform all or partial function of cold ion evacuation system 209 by absorbing the cold ions after their deceleration rather than permitting them to pass through to be evacuated thereafter. In these embodiments energy recovery electrode 204 may be made solid (non-permeable), preferably of material with high absorbing efficiency towards the relevant ion species. In the case of D or T hydrogen isotopes the natural choice of material is palladium. Electrodes 204 may still need to be made segmented to be under-biased differently according to Eq. 4.

In related embodiments, a deflecting magnetic field B of certain configuration (not shown in FIG. 2) can be introduced to disturb the paths 210 of the left and right incoming ions in order to disallow ion collisions everywhere except near the center of active space 214. The spherical shape of the energy recovery electrode 204 may be disturbed accordingly to maintain the normal incidence condition represented by Eq. 2.

In other related embodiments, the working mode of the 1D fusor device described here may resemble the well-known “star mode” of a conventional fusor device, with the key difference being that the “star” is only two-pronged, whereas the bulk of the device lacks plasma and is maintained at a deep vacuum level during operation.

In related embodiments, an “under-bias” dE is strong enough to disallow reflection of the lower-energy post-scattered ions back to active space 214, upholding the design principle of maintaining nearly head-on collisions. Whereas ideally, the post-scattered ions all have the same energy, technological imperfections lead to a narrow distribution of energies. In particular, deviation from the head-on collision condition Eq. 1a by an angle δ leads to the post-scattered ions having energy slightly above and slightly below the initial energy. The worst-case scenario (the largest energy deviation dE) occurs for the ions scattered at a right angle. In this case the energy excess/deficiency is

$$d E ( 9 {0}^{∘} ) = 2 {E}_{0} S in ( δ / 2 ) , \qquad ( Eq . 3 )$$

where E₀ is the Accelerating Electrode bias times the ion's electric charge. Absent additional ion focusing elements, the maximum angle δ can be estimated as δₘₐₓ≈2α=the angular size of ion injection Port 207, 208, as seen from the center of the device. The amount of energy dE may not be fully recovered and thus contribute to losses.

Since the majority of Coulomb scattering events occur at small scattering angles (see detailed discussion below), and since the energy excess/deficiency dE is less at small scattering angles, the areas of energy recovery electrode 204 near main axis 210 may be under-biased by a lesser amount in order to limit such losses. In some embodiments, energy recovery electrode 204 may be made segmented to achieve this goal, each segment under-biased by dE₁, dE₂, dE₃ etc. The formula for dE as a function of the angle χ offset from the main axis 210 is given below in Eq. 4. Parts of the cold ion evacuation system 209 can be made segmented as well to maintain a proper bias between them and energy recovery electrode 204 (Vₑ₁, Vₑ₂, Vₑ₃ etc., not shown).

### Net Energy Gain Feasibility Estimate

As discussed above, the D-D reaction (as other single-species reactions) has notable parametric disadvantages over the D-T reaction: it has a 27 times lower reaction cross-section (i.e. reaction probability), requires about 8 times greater voltages, and has a 4.9 times lower fusion energy yield. On the pro side is the simpler single-species device design. Calculations demonstrate that energy gains can exceed losses, even in the D-D Basic Design I reactor, as described above. However, a substantially better Gain/Loss ratio is expected for the D-T designs described subsequently.

First, the energy loss dE per ion due to the deviations from head-on collisions in the reactor depicted in FIG. 2 is estimated. A detailed consideration of the Coulomb scattering process is taken into account.

The majority of the ions in the opposite beams remain un-scattered from a technical point of view. Formally, the long-range nature of Coulomb force in vacuum makes every ion scatter, albeit to a small angle. For the technical purpose of this description, the “un-scattered” ions are those ions that, upon passing the reaction zone, do not deviate too much so as to still hit the area of ion collection ports 211 or 212.

In Basic Design I as depicted in FIG. 2, these ions are permitted to be reflected back and to accelerate again towards reaction zone 206, making multiple attempts at the fusion reaction, until they are either scattered away from the head-on collision trajectory (most likely), leading to some energy loss, or undergo fusion, leading to energy gain. The gain/loss (G/L) balance for a device of specific dimensions may be estimated. In the following illustrative example of such estimation, the dimensions chosen for ease of illustration, and are not presented as any sort of required limitation to the scope of the present subject matter.

The diameter of each of ion collection ports 211 and 212 may be assumed to be 5 mm in a 30-cm-diameter active space 214. Further, in this example, the accelerating electrode bias E₀ may be set to −500 KV to maximize the D-D fusion cross section.

Thus, un-scattered ions are the great majority of all ions that scatter at angles less than α=arcsin(5/300)≈1°. The rest of the ions that scatter at angles greater than 1° have the Coulomb scattering cross-section σ_{C}=235 barn. This large number is to be compared against the D-D fusion cross-section σ_{F} of only 0.2 barns—a dramatic mismatch—which exemplifies the hurdles of the kinematic fusion approaches, and which the present design aims to overcome. In other words, for every ion pair undergoing fusion reaction, about σ_{C}/σ_{F}=1200 ions are scattered elastically away from the head-on trajectory without undergoing fusion. Advantageously, the kinetic energy of these ions is recovered as fully as possible to achieve net energy gain.

On the positive side of the net energy balance is the energy yield E_{F}=3.61 MeV released by a successful D-D fusion reaction.

The ions hitting other ions within the cross-section σ_{C} are scattered beyond the opening of ion collection port 211 or 212 and fly along trajectories similar to 210 and 210′. The energy loss dE is the worst for the ions scattered at a right angle, and is given by Eq. 3, which yields about 3.3% of E₀. Fortunately, the fraction of these scattering events is very small.

The majority of ions that do scatter are scattered to small angles χ. The energy loss dE for these ions can be calculated as:

$$d E ( χ ) = 2 {E}_{0} Sin ( δ / 2 ) Sin ( χ ) , \qquad ( Eq . 4 )$$

which yields dE≈0.06% of E₀ for the ions scattered at χ=1°. The weighted average of dE over all scattering angles χ>1° is 0.13% of E₀.

Assuming efficiency n of the fusion energy recovery, the energy balance has, on the gain side, η×σ_{F}×E_{F} per ion pair vs. 0.0013 E₀×σ_{C} per ion on the loss side. The Gain/Loss ratio is, therefore,

$$G / L = η {σ}_{F} {E}_{F} / ( 2 \times 0.0013 {E}_{0} {σ}_{C} ) = 2.2 η , \qquad ( Eq . 5 )$$

attesting to the technical feasibility of the device. The factor 2 in the denominator is due to the fusion reaction involving a pair of ions.

Higher practical n values are facilitated for the D-D reaction by the fact that 63% of the fusion yield is carried away by charged particles (vs. only 20% for D-T), allowing for direct energy conversion.

### Beam Defocusing Estimates

### 1. Defocusing Due to the Initial Ion Temperature

Assuming the cold ion injectors 207, 208 are at temperature T, the normal component of the thermal motion of ions is of the order vₙ≈Sqrt (k_{B}T/m), where k_{B} is the Boltzmann constant and m the ion mass. This velocity component contributes to the beam defocusing and consequent deviation from head-on collision via the time-of-flight for the ions. Depending on the device parameters and dimensions, the cold ion injector may need to be kept at cryogenic temperatures to limit thermal defocusing. For the present embodiment, ambient room temperature is assumed.

The time-of-flight from ion injector 207, 208 to reaction zone 206 is, approximately, t=(R₂/v₀)× (1/2) Sqrt (R₂/R₁), where R₂ is the radius of active space 214, R₁ is the radius of the accelerating electrode, and v₀-Sqrt (2E₀/m) is the ion velocity in the reaction zone. For the described dimensions, assuming R₁₌₃ cm, these formulae lead to thermal defocusing of less than 0.1 mm (0.2 mm contributed to the beam diameter).

### 2. Internal Coulomb Defocusing

The usual critique of accelerated beam fusion reactors state that the beam densities necessary to achieve a certain large energy output lead to beam self-defocusing because of the internal Coulomb repulsion. The present approach does not promise large energy output. The energy output may be limited by this and other factors. Here, the focus is on limiting the losses rather than on increasing the gains. The main goal is to provide a fusion device with a net-positive energy output, albeit possibly small and not necessarily on the scale of a power station for a single device. However, it may be possible for the energy output to be scaled up by adding additional beam focusing elements or by other means, as long as the design principles taught by the present disclosure are followed.

### Embodiments of Basic Design IB

In embodiments of Basic Design IB, a fusion reactor that is similar to Basic Design I is provided, except the ion collection ports 211, 212 are separate openings from the ion injection ports 207, 208 in order to detach ion injection from the un-scattered cold ion recovery. The paths of the ions may be modified by deflecting magnetic fields in order to direct each beam towards the respective ion collector port 211, 212. This allows the cold ion injectors to have a more complex design in order to better focus the cold ions on their pass through the injection port towards reaction zone 206. Basic Design IB preferably has a more efficient cold ion evacuation system 209 in order to prevent the collected ions from re-entering the active space 214 at the spot different from the ion injection port 207, 208, thereby upholding the design principle of maintaining nearly head-on collisions.

### Embodiments of Basic Design II

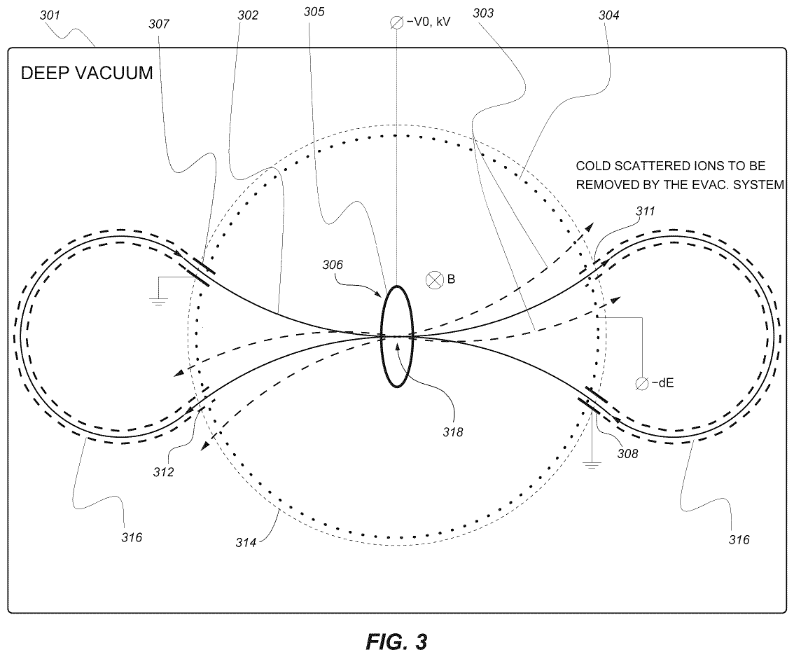

Basic Design II according to a related type of embodiment is illustrated in FIG. 3. Basic Design II comprises vacuum chamber 301, which contains active space 314, reaction zone 306, accelerating electrode 305, energy recovery electrode 304, ion beam 302, and scattered ion paths 303, which are similar in principle to analogous components described above with reference to FIG. 1 and FIG. 2. A distinguishing feature of the Basic Design II embodiments is 8-shaped ion storage ring 316, arranged to cross itself at 180° in the reaction zone 306. Storage ring 316 facilitates ion beam 302 entering and exiting active space 314 through ion beam injection ports 307, 308 and beam collection ports 311, 312. In some embodiments of Basic Design II, beam collection ports 311, 312 may coincide with the opposite beam injection ports 308, 307, respectively, or may be provided separately as additional ports in the energy recovery electrode (Basic Design IIB).

In some embodiments, the beam energies at beam injection ports 307, 308 and beam collection ports 311, 312 are significantly smaller than those in reaction zone 306; hence, the beams passing through the ports 307, 308, 311, 312 may be considered to be cold beams. The acceleration of beams 302 is effected by the electric field inside active space 314 produced by the electric bias between acceleration electrode 305 and the energy recovery electrode 304.

Notably, since the device, including energy recovery electrode 304, is a 3D structure, scattered ion paths 303 may be outside the plane of the diagram, meaning they may be at any angle in 3D space.

### Embodiments of Basic Design III

Basic Design III may be considered as a variation of Basic Design II as depicted in FIG. 3, except that in some embodiments of Basic Design III (not shown), the energy recovery electrode surrounds most, or all, of storage ring structure 316, and is positively-biased with respect to the latter. Hence active space 314 includes the storage ring 316. In these embodiments, the entire length of the ion beams in the storage ring can be maintained at hot reaction energies.

In other embodiments the ion energy in the part of storage ring 316 outside active space 314 may be maintained at any intermediate value between cold and hot ion energy.

### Embodiments of Basic Design IV

In some embodiments, Basic Designs II and III are modified with the single 8-shaped ring 316 replaced with two storage rings with essentially collinear sections 318 overlapping in reaction zone 306.

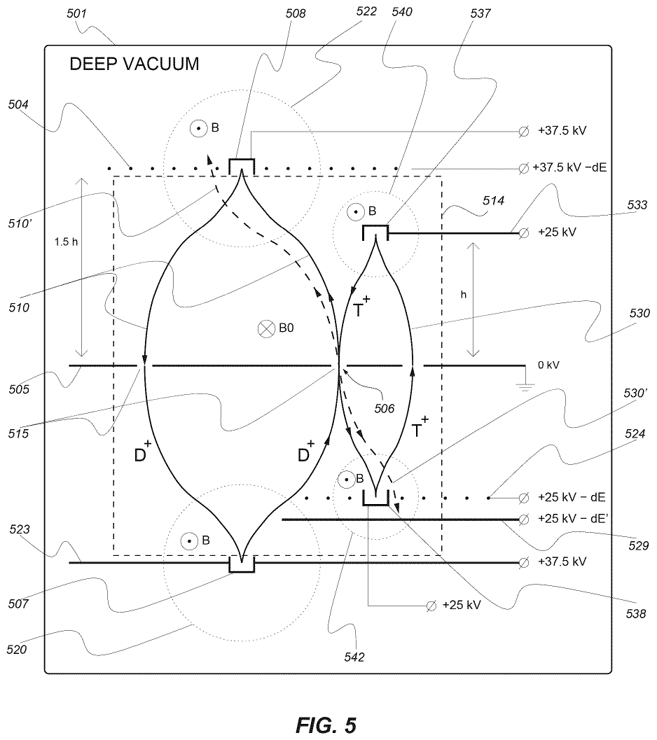

Since said 2-ring design is also applicable to two-species reactions, it is described below with reference to FIG. 5.

A deflecting magnetic field B can be used to separate the injection and collection beam paths. The ion beam may enter and exit active space 314 as in Basic Design II or be contained entirely within the active space as in Basic Design III. Various embodiments may have beam energy outside the active space having values other than E₀ and zero.

### Multi-Species Nuclear Reactions

As discussed above, the D-T reaction offers substantial advantages over single-species fusion reactions towards achieving favorable gain/loss ratio due to the higher cross-section, higher fusion yield, and lower energies required. Other dual-species reactions may offer these and other advantages. In the following, the D and T symbols are used to denote generic lighter and the heavier ions, respectively, having the D-T reaction as a preferred example.

In the following, two-species versions of both the fusor-style Basic Design I and storage-ring style Basic Design II-IV are disclosed.

### Two-Species Embodiments Based on Fusor-Style Configuration

Setting aside the details of the ion injection and the scattered ion recovery, the fusor-based configuration admits a steady-state one-dimensional phase space distribution where both ion species oscillate along the main axis, and where the conditions set by Eqs. 1a and 1b are still fulfilled.

The kinetic energy E_{T} of the heavier ions in the reaction zone has to be lower than the respective energy Ep of the lighter ions according to Eq. 1b. Specific to the D-T reaction, the preferred energy values to maximize the D-T fusion cross-section are E_{D}=37.5 keV and E_{T}=25 keV. Since E_{T} is less than E_{D}, the amplitude of the oscillations of the T ions has to be smaller.

If the potential difference E₀ between the accelerating electrode and the outer wall is set to the value E₀=E_{D}, as in the same-species embodiment, the turning point of the T ions is located inside the active space a certain distance between the reaction zone and the outer wall, where the D ions have considerable velocity. Notably, the conditions set by Equations 1a and 1b are still fulfilled for each of the three possible types of ion collisions: D-T, D-D and T-T. Upon any of these types of collision, the scattered D or T ions still follow the paths similar to path 210′ in FIG. 2, with their initial energies equal to the pre-collision values E_{D} or E_{T}, respectively.

One drawback of the fusor geometry is that the scattered T ions lose their kinetic energy and stop in the interior of the active space, where the scattered D ions still have energy E_{D}-E_{T} remaining. Thus, it is difficult (though not entirely impossible) to envision the cold ion evacuation system removing the cold T ions effectively, yet allowing the D ions to travel further towards the periphery of the active space and slow down in a controlled manner.

One way to address this drawback is to accept the residual energy loss (equal to E₀/3 per scattered D ion, or E₀/6 per D-T scattering event, for the D-T reaction) and rely on the chance that the parametric advantages of the D-T reaction referenced above might outweigh the loss. Maintaining the relative number of D ions at a smaller value than the number of T ions can be used to lower the energy loss.

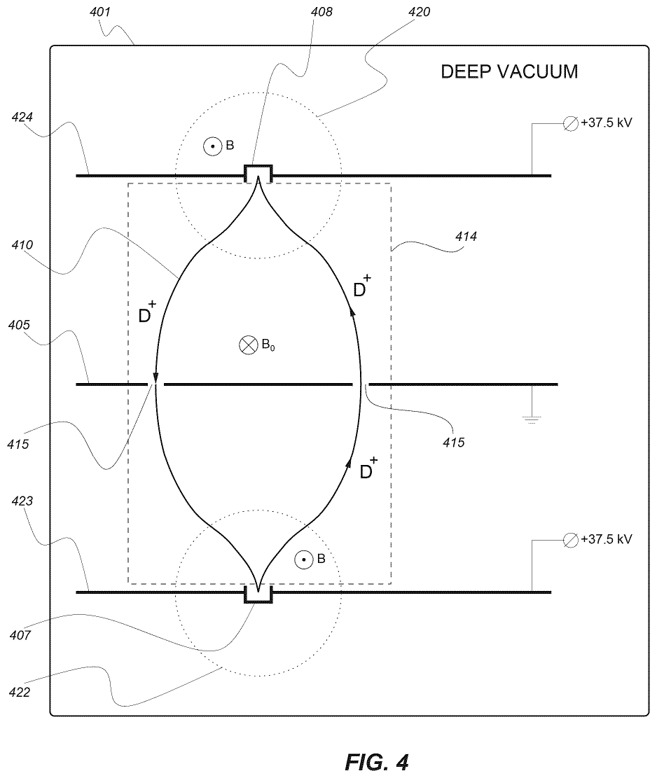

As an improvement to this approach, some embodiments include means for bending the paths of the D and Tion beams in such a way as to spatially separate the majority of the scattered T ions from the majority of the scattered D ions. This is achieved in one type of embodiment by applying a magnetic field of a certain configuration, examples of which are shown schematically in FIG. 4 and FIG. 5. Given such separation of the scattered T and D ions, distinct energy recovery electrodes situated in the path of the majority of the scattered ions of each type facilitate slowing down such respective majorities of the scattered ions of each type to recover their energy efficiently. Each of the distinct energy recovery electrodes may be maintained at suitable voltage corresponding to the respective energy of each type of scattered ions, the energy of which is to be recovered.

Since the majority of the Coulomb scattering events result in scattering to small angles, the back-and-forth oscillating motion of the ions is replaced with a directional flow where the T ions enter the reaction zone from one side and the D ions enter the reaction zone from the opposite side. This can be achieved with magnetic fields of moderate strength that can be produced with permanent magnets, requiring no additional energy to maintain.

FIG. 4 illustrates schematically a single-species configuration where the back-and-forth oscillating motion is replaced with leaf-shaped path 410, such that the forward and backward paths of the ions are spatially separated. This is achieved in one example, as illustrated, by arranging active space 414 in an external magnetic field B₀ that curves ion path 410 to the left, and providing an opposite magnetic field B near cold ion injector 407 and cold ion collector 408 (within proximity 420, 422), which is operative to curve ions path 410 to the right.

In this example, two separate energy recovery electrodes, 423 and 424, are provided. Each electrode 423, 424 has a planar shape, and a port, such as an aperture, coinciding with a corresponding cold ion injector 407, 408. Since this example is a simplified, single-species, embodiment, both energy recovery electrodes 423 and 424 are at the same potential. However, in multi-species embodiments the potential at the different energy recovery electrodes may differ from one another.

In the embodiment as depicted in FIG. 4 ports 407 and 408 play the role of both ion injectors and ion collectors, in the manner similar to Basic Design I (FIG. 2).

The overall arrangement is situated in vacuum chamber 401, which may include a cold ion evacuation system (not shown) similar in principle and structure to those described in the foregoing embodiments.

The particular example illustrated in FIG. 4 is based on a computer simulation in the planar capacitor geometry with B₀=0.14 Tesla, B=0.28 Tesla, distance between electrodes 405 and 423 or 424 h=10 cm, and the various voltages as shown. Accelerating electrode 405 has a planar shape with apertures 415 situated precisely at the points where the forward and backward beams cross the plane. The positions of apertures 415 can be determined for any given device configuration in accordance with techniques known by a person skilled in the art, such as by way of a computer simulation.

FIG. 5 is a schematic diagram illustrating a dual-species fusion reactor according to some embodiments. It combines two leaf-shaped loops such as the leaf-shaped loop described above with reference to FIG. 4 for each of the two ion species, arranged next to each other to overlap in such a manner that head-on collisions of the two species are allowed in the reaction zone 506. As depicted, the reactor includes vacuum chamber 501. Vacuum chamber 501 contains active space 514, in which two separate D and T leaf-shaped paths, 510 and 530, are each directed in such a way that the D ions traveling in their forward direction (upward as depicted) from port 507 to port 508 have a chance to collide head-on with the T ions traveling in their forward direction (downward as depicted) from port 537 to port 538. The return flow for the ions from port 508 port 507 and from port 538 to port 537, respectively, occur along separate paths due to the deflecting magnetic fields B₀ and B as described above with reference to FIG. 4.

In the embodiment as depicted in FIG. 5 the ports 507, 508, 537 and 538 play the role of both ion injectors and ion collectors, in the manner similar to FIG. 4 and to Basic Design I (FIG. 2).

FIG. 5 depicts schematically proximity areas 520, 522, 540 and 542 with the magnetic field B that curves the ion paths to the right, and the magnetic field B₀ in the active space that curves the paths to the left.

In a manner similar to that described in the single-species embodiment (FIG. 4), the majority of the ions do not scatter and continue their travel along the respective leaf-shaped path 510, 530. The ions that do collide in reaction zone 506 deviate from their original trajectory and follow paths similar to 510′ and 530′. Due to the presence of the deflecting fields, paths 510′ and 530′ are also curved; however, they are still predictable and are a certain function of the scattering angle χ. The initial velocities of the scattered ions correspond to the respective ion hot energies E_{D} or E_{T}, since the conditions of Eqs. 1a and 1b are maintained in reaction zone 506.

The majority of the scattered D ions that are scattered at small angles and follow paths like 510′ reach energy recovery electrode 504 (most of these ions being in the proximity of port 508), return most of their energy to the circuit, pass by energy recovery electrode 504 and are removed by a cold ion evacuation system (not shown), in a manner similar to the single-species designs described above. The energy recovery electrode 523 functions electrostatically in a similar manner to the energy recovery electrode 504. It may or may not need to be porous as the ions scattered in the reaction zone are not expected to reach it. The same description applies to electrode 533 for the heavier T ions. In order to also maintain the condition set by Eq. 2, electrode 504 may have a curved shape, such as to accept each scattered ion trajectory at an essentially normal angle. The ideal curvature (not shown for simplicity) can be determined using techniques known by a person skilled in the relevant art, such as using a computer simulation for a particular device configuration.

Notably, since the device, including energy recovery electrode 504, is a 3D structure, scattered ion paths similar to 510′ and 530′ may be outside the plane of the diagram, meaning they may be at any angle in 3D space.

The heavier T ions that undergo a scattering event in reaction zone 506 follow a similar path 530′, reach corresponding energy recovery electrode 524 (biased at the level corresponding to the lower energy E_{T} of the heavier ions), return most of their energy to the circuit, pass by electrode 524, and are removed by the cold ion evacuation system. The shape of electrode 524 may be curved in a manner similar to that of energy recovery electrode 504 (curvature not shown).

In related embodiments, to achieve recovery of the heavier T ions, some parts of the evacuation system are now inside the active space (depicted schematically at 529). It is preferable, as in the same-species case, to not allow substantial quantities of such ions to be reflected back towards accelerating electrode 505, as these ions will no longer be in compliance with the conditions set by Eqs. 1a and 1b. One practical way to achieve this is to place an electrode 529 at a slight negative bias dE′ so as to attract and absorb any T ions that pass though electrode 524 and to disallow their secondary emission towards the center of active space 514. Electrode 529 may contain or be made of palladium or another absorbing material, as discussed in Basic Design I. The same technique may also be employed for a cold ion evacuation system outside the active space in related embodiments.

In some other embodiments energy recovery electrodes 504 and 524 may perform all or partial function of the cold ion evacuation system by absorbing the cold ions after their deceleration rather than permitting them to pass through to be evacuated thereafter. In these embodiments energy recovery electrodes 504 and 524 may be made solid (non-permeable), preferably of material with high absorbing efficiency towards the relevant ion species. In the case of D or T isotopes of hydrogen the natural choice of material is palladium. Electrodes 504 and 524 may still need to be made segmented to be under-biased differently according to Eq. 4.

Similar to FIG. 4, accelerating electrode 505 has a planar shape with apertures 515 situated precisely at the points where the forward and backward beams cross the plane. The positions of apertures 515 can be determined for any given device configuration in accordance with techniques known by a person skilled in the art, such as by way of a computer simulation

### Multi-Species Embodiments Based on Storage Ring Configuration

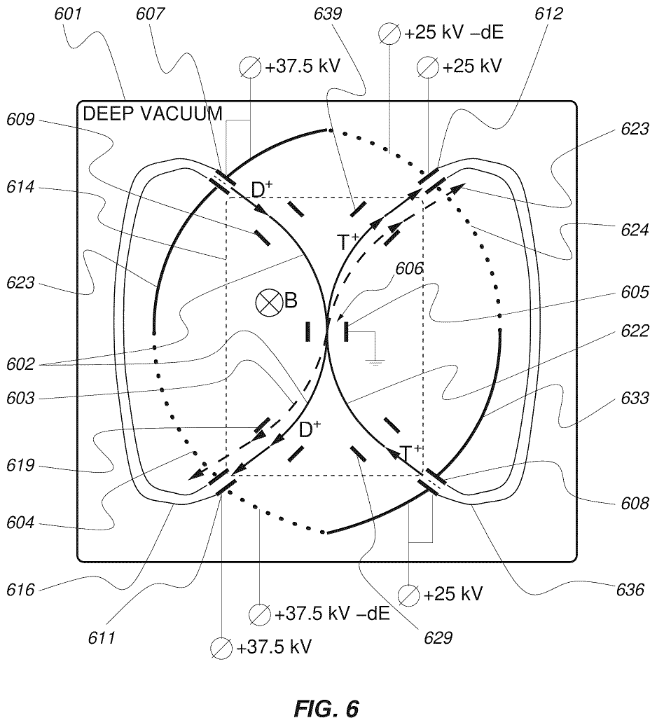

FIG. 6 illustrates a two-species embodiment based on two ion storage rings and functioning in a manner similar to Basic Design II for the single-species case. Vacuum chamber 601, which contains active space 614, reaction zone 606, accelerating electrode 605, energy recovery electrodes 604 and 624 for the D and T ions, respectively, ion beams 602 and 622, and scattered ion paths 603 and 623, which are similar in principle to analogous components described above with reference to FIG. 3 as well as FIGS. 1 and 2. A distinguishing feature of this two-species embodiment are two ion storage rings 616 and 636 replacing a single 8-shaped storage ring 316 in FIG. 3. Storage rings 616 and 636 are arranged to overlap at 180° in the reaction zone 606. They facilitate ion beams 602 and 622 carrying D and T ions, respectively, entering and exiting active space 614 through ion beam injection ports 607, 608 and beam collection ports 611, 612.

In some embodiments, the beam energies at beam injection ports 607, 608 and beam collection ports 611, 612 are significantly smaller than those in reaction zone 606; hence, the beams passing through the ports 607, 608, 611, 612 may be considered to be cold beams. The acceleration of beams 602, 622 is effected by the electric field inside active space 614 produced by the electric bias between acceleration electrode 505 (shown as grounded) and the electrodes 623 and 633, respectively.

FIG. 6 depicts schematically optional beam focusing elements 609 and 629, such as electrodes, magnets or a combination thereof, that may be provided to better focus the beams on their paths towards the reaction zone, as well as similar optional focusing elements 619 and 639 for the outgoing beams.

Magnetic field B in the active region, normal to the plane of the diagram, curves paths of each ion beam to the left, so that the beam overlap area is confined to reaction zone 606.

In a manner similar to that described in the single-species embodiment (FIG. 3), the majority of the ions do not scatter and continue their travel along the respective storage rings 616 and 636. The ions that do scatter elastically in reaction zone 606 deviate from their original trajectory and follow paths similar to 603 and 623. Due to the presence of the deflecting fields, paths 603 and 623 are also curved; however, they are still predictable and are a certain function of the scattering angle χ. The initial velocities of the scattered ions correspond to the respective ion hot energies E_{D} or E_{T}, since the conditions of Eqs. 1a and 1b are maintained in reaction zone 606.

The majority of the scattered ions that are scattered at small angles and follow paths like 603 or 623 reach their respective energy recovery electrodes 604 and 624 (most of these ions being in the proximity of beam collection ports 611 and 612), return most of their energy to the circuit, pass by energy recovery electrodes 604 and 624 and are removed by a cold ion evacuation system (not shown), in a manner similar to the single-species designs described above. The electrodes 623 and 633 may or may not need to be porous as the ions scattered in the reaction zone are not expected to reach them. In order to also maintain the condition set by Eq. 2, energy recovery electrodes 604 and 624 may have a curved shape, such as to accept each scattered ion trajectory at an essentially normal angle. The ideal curvature can be determined using techniques known by a person skilled in the relevant art, such as using a computer simulation for a particular device configuration.

Since energy recovery electrode 624 is at a significantly different electrostatic potential than electrode 623, a sufficient technological gap may be needed between them (not shown in FIG. 6 for simplicity). The same description applies to the pair of electrodes 604 and 633. A gap can be introduced by having the electrodes not cover the entire solid angle or by having the electrodes at a different distance from the reaction zone.

### Embodiments of Basic Design III

Basic Design III (2-species) may be considered as a variation of Basic Design II (2-species) as depicted in FIG. 6, except that in some embodiments of Basic Design III (2-species) (not shown), one or both storage rings 616, 636 may be located inside active space 614, similar to the single-species Basic Design III. In these embodiments, the entire length of the ion beams in the storage ring can be maintained at hot reaction energies. In yet other embodiments the ion energy in the parts of storage rings 616, 636 outside active space 614 may be maintained at any intermediate value between cold and hot ion energies.

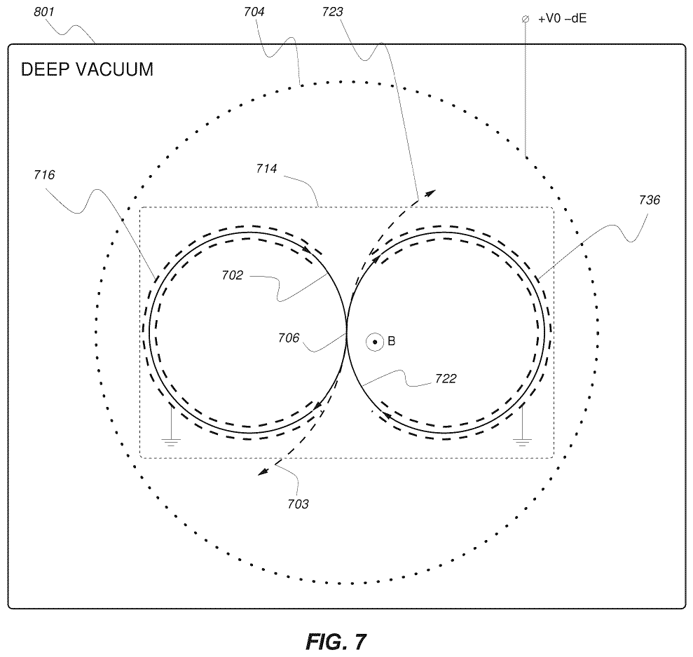

FIG. 7 illustrates an embodiment similar to the two-ring embodiment in FIG. 6, but having storage rings 716 and 736 contained entirely inside active space 714. The numbers generally correspond to the numbers in FIG. 6. A single-species embodiment is depicted for simplicity, whereas similar arrangement is applicable to two-species variants as well.

Vacuum chamber 701, which contains active space 714, reaction zone 706, and energy recovery electrode 704. Storage rings 716 and 736 are arranged to overlap at 180° in the reaction zone 706, to satisfy Eq. 1b. The ion energies in the rings are calibrated to satisfy Eq. 1a. No ion emitting or collecting ports are shown explicitly, but can be identified with the ends of the dashed storage rings structures 716 and 736.

Magnetic field B in the active region, normal to the plane of the diagram, curves paths of each ion beam to the right, in such a manner that the beam overlap area is confined to the reaction zone 706.

The un-scattered ions continue their travel along the respective paths 702 and 722 to circulate in the rings. The ions that do scatter elastically in reaction zone 706 deviate from their original trajectories and follow paths similar to 703 and 723. Due to the presence of the deflecting fields, paths 703 and 723 are also curved; however, they are still predictable and are a certain function of the scattering angle χ. The initial velocities of the scattered ions equals the respective ion hot energy, since the conditions of Eqs. 1a and 1b are maintained in reaction zone 706. The scattered ions leave the active space along paths similar to 703 and 723, reach energy recovery electrode 704 and decelerate due to its positive bias against the storage ring structures 716 and 736, shown as grounded. Cold scattered ions are then removed by the evacuation system (not shown).

Notably, scattered ion paths 703 and 723 may not lie in the plane of the diagram, but can be at any angle in 3D space, and the device, including energy recovery electrode 704 is a 3D structure.

### Electric Circuit Embodiments

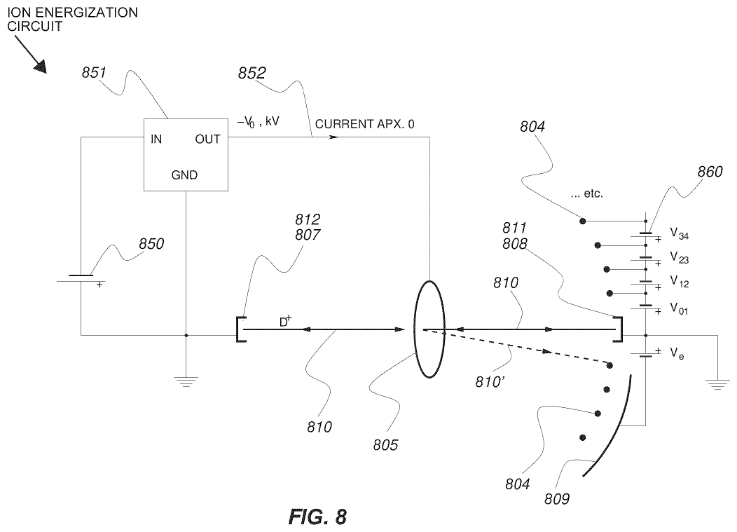

FIG. 8 is a simplified schematic diagram illustrating the electrodes and their connections to the ion energizing circuit according to some embodiments. The reference numerals generally correspond to the reference numerals of analogous features of FIG. 2. Ion injection ports 807 and 808 may double as ion collection ports 812 and 811, as in Basic Design I (FIG. 2). The cold ions accelerate along main axis 810 by the electrostatic attraction force created by the negatively-biased accelerating electrode 805 having voltage VO. This voltage is supplied by power source 850 and maintained at a desired level by voltage regulator 851 via high-voltage lead 852.

FIG. 8 shows electrodes pertaining to single ion species; additional voltage regulator(s) like 851 in embodiments involving multiple beams are used in order to tune the beam energies to comply with Eq. 1a.

Energy recovery electrode 804 is shown segmented, each segment under-biased with respect to the cold ion collector 811 by voltages dE₁=V₀₁, dE₂=V₀₁+V₁₂, dE₃=V₀₁+V₁₂+V₂₃, etc. produced by low-voltage sources 860 as prescribed by Eq. 4.

Upon head-on collision or a missed collision, the non-reacted and un-scattered ions (the majority thereof) leave reaction zone 806 along main axis 810, decelerate due to the electric field produced by the potential difference between accelerating electrode 805 and ion collector 811, and transfer energy back to the circuit as they reach ion collector 811 as cold (low energy) ions. Thus, the ions oscillating back and forth along the path 810 do not draw power from the electric circuit.

The ions that undergo an elastic scattering event leave reaction zone 806 along paths similar to 810′ and having initial velocities v₀ identical to that of the un-scattered ions. These ions approach energy recovery electrode 804, slow down under the potential difference between accelerating electrode 805 and energy recovery electrode 804, and transfer nearly all of their kinetic energy back to the electric circuit, then pass beyond energy recovery electrode 804 as cold ions and are collected and removed by cold ion evacuation system depicted schematically as partial arc 809.

In order to better illustrate the energy recovery process, it is noted that the scattered ions carry certain electric current with them. When or before they are removed, they are necessarily neutralized due to Kirchhoff's law, preventing charge buildup, by the electrons coming from the evacuation system 809 or, possibly, from energy recovery electrode 804. These electrons carry the same current through the rest of the circuit, completing the circuit. Notably, the power drawn from the electric circuit because of this current is small, as it involves only small voltages in the range of Volts (rather than VO in the range of tens of hundreds of kilovolts), times the small value of the scattered ions' current. The current carried by high-voltage lead 852 is zero or very small, meaning that zero or very small power is drawn from the power source through the high-voltage part of the circuit.

### Additional Notes and Examples

Example 1 is a nuclear fusion reactor, comprising: a vacuum chamber defining an interior, the vacuum chamber operative to maintain a deep vacuum in the interior; at least one ion injection port; an ion energization circuit; an active space within the interior, the active space including an ion beam focusing arrangement comprising a plurality of electrodes arranged to direct a first ion beam and a second ion beam to have essentially uniform energies of ions within each beam, and essentially uniform velocity vectors at points within each path of each respective ion beam, and to collide substantially head-on with each other within a reaction zone in the active space, wherein each ion beam is sourced via the at least one ion injection port, wherein the ratio of the energy of the ions of the first beam to the energy of the ions of the second beam equals the inverse ratio of the respective ion masses, and wherein the plurality of electrodes are coupled to the ion energization circuit; a first energy recovery electrode coupled with the ion energization circuit, the first energy recovery electrode being positively biased according to charge and energy of the first ion beam, and operative to transfer kinetic energy of scattered ions of the first ion beam to the ion energization circuit, thereby producing cold ions to be evacuated from the active space.

In Example 2, the subject matter of Example 1 includes, wherein the first energy recovery electrode is situated within the active space.

In Example 3, the subject matter of Examples 1-2 includes, wherein the first energy recovery electrode is coextensive with the active space.

In Example 4, the subject matter of Examples 1-3 includes, wherein the first energy recovery electrode comprises an ion-permeable construction to permit the cold ions to pass through the first energy recovery electrode.

In Example 5, the subject matter of Examples 1˜4 includes, wherein the first energy recovery electrode comprises an ion-absorbing material.

In Example 6, the subject matter of Examples 1-5 includes, wherein the first energy recovery electrode is arranged such that the scattered ions impinge on the first energy recovery electrode at an angle that is normal to the first energy recovery electrode.

In Example 7, the subject matter of Examples 1-6 includes, wherein the first energy recovery electrode is positively biased according to the charge and energy of the first and the second ion beams.

In Example 8, the subject matter of Examples 1-7 includes, a second energy recovery electrode coupled with the ion energization circuit, the second energy recovery electrode being positively biased according to charge and energy of the second ion beam, and operative to transfer energy of scattered ions of the second ion beam to the ion energization circuit, thereby producing cold ions to be evacuated from the active space.

In Example 9, the subject matter of Examples 1-8 includes, a cold ion evacuation system arranged to remove cold ions from the active space.

In Example 10, the subject matter of Example 9 includes, wherein the cold ion evacuation system includes at least one negatively-biased capture electrode.

In Example 11, the subject matter of Example 10 includes, wherein the at least one negatively-biased capture electrode comprises at least one palladium electrode.

In Example 12, the subject matter of Examples 1-11 includes, wherein the ion beam focusing arrangement further includes at least one magnetic field source arranged to bend the first ion beam or the second ion beam.

In Example 13, the subject matter of Examples 1-12 includes, at least one ion collection port arranged to receive ions of the first or the second ion beam, and to facilitate re-energization of those received ions.

In Example 14, the subject matter of Example 13 includes, wherein the at least one ion collection port is situated together with the at least one ion injection port.

In Example 15, the subject matter of Examples 13-14 includes, wherein the at least one ion collection port is situated apart from the at least one ion injection port.

In Example 16, the subject matter of Examples 1-15 includes, an acceleration electrode situated proximate the reaction zone, wherein the acceleration electrode is negatively biased and arranged to accelerate ions of the first and the second ion beams towards the reaction zone, and to decelerate non-collided ions of the first and the second ion beams as those non-collided ions pass by the reaction zone.

In Example 17, the subject matter of Examples 1-16 includes, wherein the active space is spherical in shape.

In Example 18, the subject matter of Examples 1-17 includes, wherein the ion beam focusing arrangement includes electric or magnetic fields to direct the first ion beam and the second ion beam along a respective looped path.

In Example 19, the subject matter of Example 18 includes, wherein the ion beam focusing arrangement establishes a respective looped path of each of the first ion beam and the second ion beam that resides inside and outside of the active space and carries hot ions in the active space and cold ions outside of the active space.

In Example 20, the subject matter of Examples 18-19 includes, wherein the ion beam focusing arrangement establishes a respective looped path of each of the first ion beam and the second ion beam that resides within the active space.

In Example 21, the subject matter of Examples 1-20 includes, wherein the ion beam focusing arrangement includes electric or magnetic fields to direct the first ion beam and the second ion beam along a leaf-shaped path that includes a forward direction and a backward direction; and wherein the first ion beam traveling in the forward direction is spatially separated from the first ion beam travelling in the backward direction, and wherein the second ion beam traveling in the forward direction is spatially separated from the second ion beam travelling in the backward direction.

In Example 22, the subject matter of Examples 1-21 includes, wherein the first ion beam comprises a first species of ions, and the second ion beam comprises a second species of ions that is different from the first species.

Example 23 is a method for operating a nuclear fusion reactor, the method comprising: providing a vacuum chamber and evacuating the vacuum chamber to maintain a deep vacuum in an interior of the vacuum chamber; directing a first ion beam and a second ion beam within an active space in the vacuum chamber along a first path and a second path, respectively, each ion beam having essentially uniform energies of ions within each ion beam, and essentially uniform velocity vectors of ions within each beam at points within each path of each respective ion beam, and to cause the first and the second ion beams to collide substantially head-on with each other within a reaction zone in the active space, wherein the ratio of the energy of the ions of the first beam to the energy of the ions of the second beam equals the inverse ratio of the respective ion masses; recovering energy of scattered ions of the first ion beam and the second ion beam, thereby producing cold ions; and evacuating the cold ions from the active space.

In Example 24, the subject matter of Example 23 includes, wherein recovering the energy of the scattered ions of the first ion beam and the second ion beam includes permitting the cold ions to pass through a permeable energy recovery electrode.

In Example 25, the subject matter of Examples 23-24 includes, wherein recovering the energy of the scattered ions of the first ion beam and the second ion beam includes providing an energy recovery electrode that is arranged such that the scattered ions impinge on the energy recovery electrode at an angle that is normal to the energy recovery electrode.

In Example 26, the subject matter of Examples 23-25 includes, wherein directing the first ion beam and the second ion beam includes energizing a plurality of electrodes and arranging or more magnets to accelerate and steer the first and the second ion beams along respective paths.

In Example 27, the subject matter of Examples 23-26 includes, wherein evacuating the cold ions includes negatively biasing at least one capture electrode.

In Example 28, the subject matter of Examples 23-27 includes, wherein directing a first ion beam and a second ion beam within the active space includes arranging at least one magnetic field to bend the first ion beam or the second ion beam.

In Example 29, the subject matter of Examples 23-28 includes, collecting non-reacted ions of the first ion beam and the second ion beam, and re-energizing those received ions and directing them towards the reaction zone.

In Example 30, the subject matter of Examples 23-29 includes, wherein directing the first ion beam and the second ion beam within the active space includes negatively biasing an acceleration electrode and arranging the acceleration electrode to accelerate ions of the first and the second ion beams towards the reaction zone, and to decelerate non-collided ions of the first and the second ion beams as those non-collided ions pass by the reaction zone.

In Example 31, the subject matter of Examples 23-30 includes, wherein directing the first ion beam and the second ion beam within the active space includes steering the first and the second ion beams along respective looped paths of each of the first ion beam and the second ion beam.

In Example 32, the subject matter of Examples 23-31 includes, wherein directing the first ion beam and the second ion beam within the active space includes establishing electric or magnetic fields to direct the first ion beam and the second ion beam along a leaf-shaped path that includes a forward direction and a backward direction, such that the first ion beam traveling in the forward direction is spatially separated from the first ion beam travelling in the backward direction, and wherein the second ion beam traveling in the forward direction is spatially separated from the second ion beam travelling in the backward direction.

In Example 33, the subject matter of Examples 23-32 includes, wherein the first ion beam comprises a first species of ions, and the second ion beam comprises a second species of ions that is different from the first species.

Example 34 is a nuclear fusion reactor, comprising: a vacuum chamber to maintain a deep vacuum in an interior of the vacuum chamber; means for directing a first ion beam and a second ion beam within an active space in the vacuum chamber along a first path and a second path, respectively, each ion beam having essentially uniform energies of ions within each ion beam, and essentially uniform velocity vectors of ions within each beam at points within each path of each respective ion beam, and to cause the first and the second ion beams to collide substantially head-on with each other within a reaction zone in the active space, wherein the ratio of the energy of the ions of the first beam to the energy of the ions of the second beam equals the inverse ratio of the respective ion masses; means for recovering energy of scattered ions of the first ion beam and the second ion beam, thereby producing cold ions; and means for evacuating the cold ions from the active space.

Example 35 is a method to implement of any of Examples 1-22.

Example 36 is an apparatus comprising means to implement of any of Examples 23-33.

The embodiments above are intended to be illustrative and not limiting. Additional embodiments are within the claims. In addition, although aspects of the present invention have been described with reference to particular embodiments, those skilled in the art will recognize that changes may be made in form and detail without departing from the scope of the invention, as defined by the claims.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as will be understood by persons of ordinary skill in the art.

Any incorporation by reference of documents above is limited such that no subject matter is incorporated that is contrary to the explicit disclosure herein. Any incorporation by reference of documents above is further limited such that no claims that are included in the documents are incorporated by reference into the claims of the present Application. The claims of any of the documents are, however, incorporated as part of the disclosure herein, unless specifically excluded. Any incorporation by reference of documents above is yet further limited such that any definitions provided in the documents are not incorporated by reference herein unless expressly included herein.

For purposes of interpreting the claims for the present invention, it is expressly intended that the provisions of 35 U.S.C. § 112(f) are not to be invoked unless the specific terms “means for” or “step for” are recited in a claim.

What is claimed is:

1. An energy recovery system for a beam collider that accelerates and collides beams of hot ions, the beam collider including a vacuum chamber that defines an interior, at least one ion injection port, and a plurality of electrodes that, when energized, are configured to form an ion beam focusing arrangement that produces, in an active space of the interior, a first ion beam of hot ions and a second ion beam of hot ions from ions injected via the at least one ion injection port, and wherein the ion beam focusing arrangement directs the ion beams to overlap and cause collisions of some of the hot ions of the first and the second beams within a collision zone in the interior, the energy recovery system comprising:
a vacuum pump coupled to the vacuum chamber, the vacuum pump configured to maintain a vacuum in the interior;
an ion energization circuit coupled to the plurality of electrodes and configured to energize the electrodes to form the first and the second ion beams which are directed head-on with one another with uniform energies and uniform velocity vectors of the hot ions within each ion beam, wherein a ratio of the energy of the ions of the first beam to the energy of the ions of the second beam equals the inverse ratio of the respective ion masses in the head-on collisions;
a first energy recovery electrode coupled with the ion energization circuit and positively biased based on known energy of scattered ions of the first ion beam that are scattered as a result of the collisions in the collision zone, the energy of the scattered ions being known based on the ratio of the energy of the ions of the first beam to the energy of the ions of the second beam being equal to the inverse ratio of the respective ion masses, the first energy recovery electrode being configured to slow down the scattered ions, and transfer kinetic energy of those scattered ions to the ion energization circuit, to produce a first set of cold ions that are evacuated from the active space.

2. The energy recovery system of claim 1, wherein the first energy recovery electrode comprises an ion-permeable construction to permit the first set of cold ions to pass through the first energy recovery electrode.

3. The energy recovery system of claim 1, wherein the first energy recovery electrode comprises an ion-absorbing material.

4. The energy recovery system of claim 1, wherein the first energy recovery electrode is arranged such that the scattered ions impinge on the first energy recovery electrode at an angle that is normal to the first energy recovery electrode.

5. The energy recovery system of claim 1, further comprising:
a second energy recovery electrode coupled with the ion energization circuit, the second energy recovery electrode being positively biased according to known energy of scattered ions of the second ion beam that are scattered as a result of the collisions in the collision zone, the energy of the scattered ions being known based on the ratio of the energy of the ions of the first beam to the energy of the ions of the second beam being equal to the inverse ratio of the respective ion masses, and wherein the second energy recovery electrode is operative to transfer sufficient kinetic energy of scattered ions of the second ion beam to the ion energization circuit to produce a second set of cold ions that are evacuated from the active space.

6. The energy recovery system of claim 1, further comprising:
a cold ion evacuation system arranged to remove the first set of cold ions from the active space.

7. The energy recovery system of claim 6, wherein the cold ion evacuation system includes the vacuum pump.

8. The energy recovery system of claim 1, further comprising:
an acceleration electrode situated proximate the collision zone, wherein the acceleration electrode is negatively biased and arranged to accelerate ions of the first and the second ion beams towards the collision zone, and to decelerate any non-collided ions of the first and the second ion beams as those non-collided ions pass by the collision zone.

9. The energy recovery system of claim 1, wherein the first ion beam comprises a first species of ions, and the second ion beam comprises a second species of ions that is different from the first species.

10. The energy recovery system of claim 1, wherein the first energy recovery electrode is under-biased by a potential difference sufficient to reduce a quantity of scattered ions that would otherwise reverse direction of their motion, and return to the collision zone.

11. A method of recovering energy in a beam collider that accelerates and collides beams of hot ions within a vacuum chamber having an interior that includes an active space and a collision zone, the beam collider including at least one ion injection port and a plurality of electrodes operable to form an ion beam focusing arrangement, the method comprising:
maintaining a vacuum in the interior of the vacuum chamber;
injecting ions into the interior via the at least one ion injection port; energizing, with an ion energization circuit, the plurality of electrodes to form, in the active space, a first ion beam of hot ions and a second ion beam of hot ions from the injected ions;
controlling the ion beam focusing arrangement to direct the first ion beam and the second ion beam head-on with one another such that ions within each of the first ion beam and the second ion beam have uniform energies and uniform velocity vectors and such that the first ion beam and the second ion beam overlap and collide within the collision zone;
setting an energy of ions of the first ion beam and an energy of ions of the second ion beam such that a ratio of the energy of the ions of the first ion beam to the energy of the ions of the second ion beam equals an inverse ratio of respective ion masses in the head-on collisions;
positively biasing a first energy recovery electrode coupled with the ion energization circuit based on a known energy of the scattered ions of the first ion beam that are scattered as a result of the collisions in the collision zone, wherein the known energy of scattered ions of the first ion beam is based on the ratio of the energy of the ions of the first ion beam to the energy of the ions of the second ion beam being equal to the inverse ratio of the respective ion masses;
slowing, with the first energy recovery electrode, the scattered ions of the first ion beam;
transferring kinetic energy of the slowed scattered ions of the first ion beam to the ion energization circuit;
producing, responsive to the slowing and transferring, a first set of cold ions; and evacuating the first set of cold ions from the active space.

12. The method of claim 11, further comprising:
positively biasing a second energy recovery electrode coupled with the ion energization circuit based on a known energy of the scattered ions of the second ion beam that are scattered as a result of the collisions in the collision zone, the known energy of scattered ions of the second ion beam being based on the ratio of the energy of the ions of the first ion beam to the energy of the ions of the second ion beam being equal to the inverse ratio of the respective ion masses;
slowing, with the second energy recovery electrode, the scattered ions of the second ion beam;
transferring kinetic energy of the slowed scattered ions of the second ion beam to the ion energization circuit to produce a second set of cold ions; and
evacuating the second set of cold ions from the active space.

13. The method of claim 12, further comprising providing a cold ion evacuation system arranged to remove the first set of cold ions from the active space.

14. The method of claim 11, further comprising negatively biasing an acceleration electrode situated proximate the collision zone to accelerate ions of the first ion beam and ions of the second ion beam toward the collision zone, and to decelerate non-collided ions of the first ion beam and non-collided ions of the second ion beam as the non-collided ions pass by the collision zone.

15. The method of claim 11, further comprising directing, with electric fields or magnetic fields of the ion beam focusing arrangement, the first ion beam along a first looped path and directing the second ion beam along a second looped path.

16. The method of claim 15, wherein directing the first ion beam along the first looped path and directing the second ion beam along the second looped path comprises establishing the first looped path and the second looped path such that each of the first looped path and the second looped path resides inside and outside of the active space and carries hot ions in the active space and cold ions outside of the active space.

17. The method of claim 15, wherein directing the first ion beam along the first looped path and directing the second ion beam along the second looped path comprises establishing the first looped path and the second looped path such that each of the first looped path and the second looped path resides within the active space.

18. The method of claim 11, further comprising directing, with electric fields or magnetic fields of the ion beam focusing arrangement, the first ion beam and the second ion beam along a leaf-shaped path that includes a forward direction and a backward direction, wherein the first ion beam traveling in the forward direction is spatially separated from the first ion beam traveling in the backward direction, and wherein the second ion beam traveling in the forward direction is spatially separated from the second ion beam traveling in the backward direction.

19. The method of claim 11, wherein the first ion beam comprises a first species of ions, and wherein the second ion beam comprises a second species of ions that is different from the first species.

20. The method of claim 11, wherein positively biasing the first energy recovery electrode comprises under-biasing the first energy recovery electrode by a potential difference sufficient to reduce a quantity of scattered ions that would otherwise reverse direction of their motion and return to the collision zone.
